(19) United States
(12) Patent Application Publication
(10) Pub. No.: US 2006/0097636 A1
(43) Pub. Date: May 11, 2006

(54) Plasma display panel

(76) Inventor: Byoungkuk Min, Bucheon-si (KR)

Correspondence Address: Song K. Jung;MCKENNA LONG & ALDRIDGE LLP, 1900 K Street, N.W., Washington, DC, 20006, US

(21) Appl. No.: 11/270,475

(22) Filed: Nov. 10, 2005

(30) Foreign Application Priority Data
Nov. 11, 2004 (KR) 10-2004-0092151

(51) Int. Cl. H01J 17/49

(52) U.S. Cl. 313/582

(57) ABSTRACT

The present invention relates to a plasma display panel. A plasma display panel according to an embodiment of the present invention comprises a first barrier rib, which partitions discharge cells in a first direction and has one or more holes formed therein, a second barrier rib, which partitions the discharge cells in the first direction and is formed between one first barrier rib and the other first barrier rib, a first electrode formed to overlap with the first barrier rib and a discharge cell region, and a second electrode formed on the second barrier rib. A plasma display panel according to an embodiment of the present invention can reduce power consumption and can reduce capacitance between barrier ribs and electrodes, while smoothly performing an address discharge.

This Nonprovisional application claims priority under 35 U.S.C. § 119(a) on Patent Application No. 10-2004-0092151 filed in Korea on Nov. 11, 2004, the entire contents of which are hereby incorporated by reference.

### BACKGROUND OF THE INVENTION

1. Field of the Invention

The present invention relates to a plasma display panel.

2. Background of the Related Art

In general, a plasma display panel comprises a front substrate and a rear substrate comprised of soda-lime glass. Barrier ribs formed between the front substrate and the rear substrate partition discharge cells. An inert gas injected into the discharge cells, such as helium-xeon (He—Xe) or helium-neon (He—Ne), is excited with a high frequency voltage to generate a discharge. When the discharge is generated, vacuum ultraviolet rays are generated. Vacuum ultraviolet rays excite phosphors formed between the barrier ribs, thus displaying images.

FIG. 1 is a perspective view schematically showing the construction of a plasma display panel in the related art. As shown in FIG. 1, the plasma display panel in the related art comprises a front panel and a rear panel. The front panel comprises a front glass substrate 10 and the rear panel comprises a rear glass substrate 20. The front panel and the rear panel are parallel to each other with a predetermined distance therebetween.

A sustain electrode pair 11 and 12 for sustaining the emission of a cell through a mutual discharge is formed on the front glass substrate 10. The sustain electrode pair comprises the scan electrode 11 and the sustain electrode 12. The scan electrode 11 comprises a transparent electrode 11a formed of a transparent ITO material and a bus electrode 11b formed of a metal material. The sustain electrode 12 comprises a transparent electrode 12a formed of a transparent ITO material and a bus electrode 12b formed of a metal material.

The scan electrode 11 receives a scan signal for scanning a plasma display panel and a sustain signal for sustaining a discharge. The sustain electrode 12 receives a sustain signal. A dielectric layer 13a is formed on the sustain electrode pair 11 and 12 and limits the discharge current and provides insulation between the electrode pairs. A protection layer 14 is formed on a top surface of the dielectric layer 13a and is formed of magnesium oxide (MgO) to facilitate a discharge condition.

Address electrodes 22 crossing the sustain electrode pair 11, 12 are disposed on the rear glass substrate 20. A dielectric layer 13b is formed on the address electrodes 22 and functions to provide insulation between the address electrodes 22. Barrier ribs 21 are formed on the dielectric layer 13b and partition the discharge cells. R, G and B phosphor layer 23 are coated between the barrier ribs 21 and the barrier ribs 21 and radiate a visible ray for displaying images.

The front glass substrate 10 and the rear glass substrate 20 are adhered by a sealing material. Inert gases, such as helium (He), neon (Ne) and xeon (Xe), are injected into the plasma display panel after an exhaust process is performed.

FIGS. 2a and 2b show stripe type barrier ribs and well type barrier ribs of a plasma display panel in the related art.

As shown in FIG. 2a, scan electrodes 30 and sustain electrodes 31 for sustaining a discharge are located on a front glass substrate. Address electrodes 32 for selecting a cell are located on a lower plate.

Luminance and efficiency characteristics of the well type barrier ribs 34 shown in FIG. 2b are superior to luminance and efficiency characteristics of stripe type barrier ribs shown in FIG. 2a. Therefore, the well type barrier ribs 34 are more preferably rather than the stripe type barrier ribs.

The well type barrier ribs comprise traverse barrier ribs and longitudinal barrier ribs.

FIG. 3 shows the construction of bus electrodes 40a and 41a disposed on traverse barrier ribs 42a of a plasma display panel in the related art.

As shown in FIG. 3, the traverse barrier ribs 42a are wider than the longitudinal barrier ribs 42b and the bus electrodes 40a and 41a are located on the traverse barrier ribs 42a. This improves luminance and efficiency accordingly.

However, since the bus electrodes 40a, 41a are disposed on the traverse barrier ribs 42a, a counter discharge between the bus electrodes 40a, 41a and address electrodes (not shown) decreases during an address discharge. Therefore, an address discharge is not sufficiently generated.

FIG. 4 shows modified traverse barrier ribs 52a of a plasma display panel in the related art. If the shape of the traverse barrier ribs 52a is modified as shown in FIG. 4, the bus electrodes 50a and 51a pass through the inside of the cells, which results in an increased address discharge. As a phosphor coating area within the cells increases, the shielding of a visible ray by the bus electrodes 50a, 51a can be compensated for.

In the structure of the traverse barrier ribs 52a and the bus electrodes 50a and 51a shown in FIG. 4, however, bus electrodes 50a, 51a and transparent electrodes 50b and 51b are exposed within the cell. Therefore, a problem arises because power consumption increases. There is also a problem in that the load of a driving circuit is increased because of the capacitance between the traverse barrier ribs 52a and the bus electrodes 50a and 51a and capacitance between the traverse barrier ribs 52a and the transparent electrodes 50b and 51b.

### SUMMARY OF THE INVENTION

Accordingly, the present invention has been made in view of the above problems, and it is an object of the present invention to provide a plasma display panel that reduces power consumption.

It is another object of the present invention to provide a plasma display panel that reduces capacitance between the barrier ribs and the electrodes.

To achieve the above objects, a plasma display panel according to a first embodiment of the present invention comprises a first barrier rib, which partitions discharge cells in a first direction and has one or more holes formed therein, a second barrier rib, which partitions the discharge cells in the first direction and is formed between one first barrier rib and the other first barrier rib, a first electrode formed to overlap with the first barrier rib and a discharge cell region, and a second electrode formed on the second barrier rib.

A plasma display panel according to a second embodiment of the present invention comprises a first barrier rib, which partitions discharge cells in a first direction and has one or more holes formed therein, a second barrier rib, which partitions the discharge cells in the first direction, and comprises a groove formed in the first direction, and is formed between one first barrier rib and the other first barrier rib, a first electrode formed to overlap with the first barrier rib and a discharge cell region, and a second electrode formed on the second barrier rib.

A plasma display panel according to a third embodiment of the present invention comprises a first barrier rib, which partitions discharge cells in a first direction and has one or more holes formed therein, a second barrier rib, which partitions the discharge cells in the first direction, and comprises a groove formed in the first direction, and is formed between one first barrier rib and the other first barrier rib, a first electrode formed to overlap with the first barrier rib and a discharge cell region, and a second electrode formed on a groove of the second barrier rib.

A plasma display panel in accordance with the present invention can reduce power consumption and can reduce capacitance between barrier ribs and electrodes, while smoothly performing an address discharge.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically showing the construction of a plasma display panel in the related art;

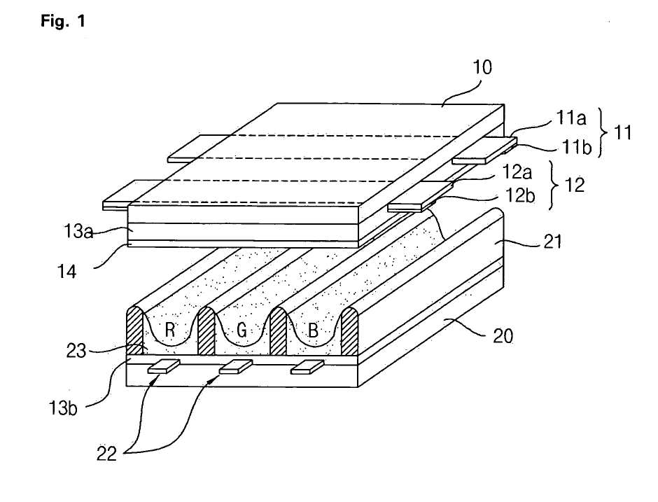

FIG. 2a shows the stripe type barrier ribs of a plasma display panel in the related art;

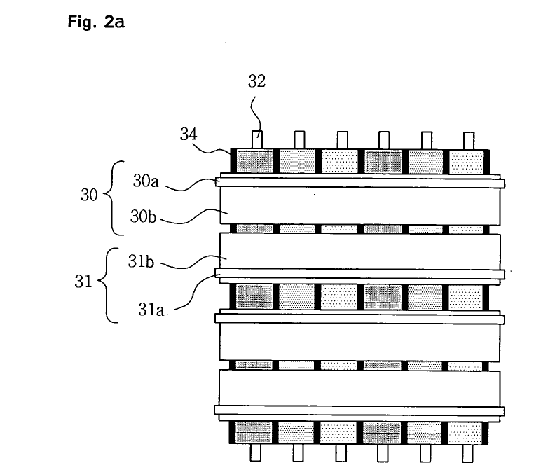

FIG. 2b shows the well type barrier ribs of a plasma display panel in the related art;

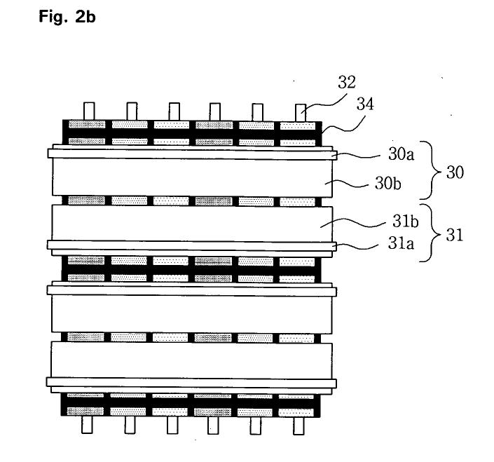

FIG. 3 shows the construction of bus electrodes disposed on traverse barrier ribs of a plasma display panel in the related art;

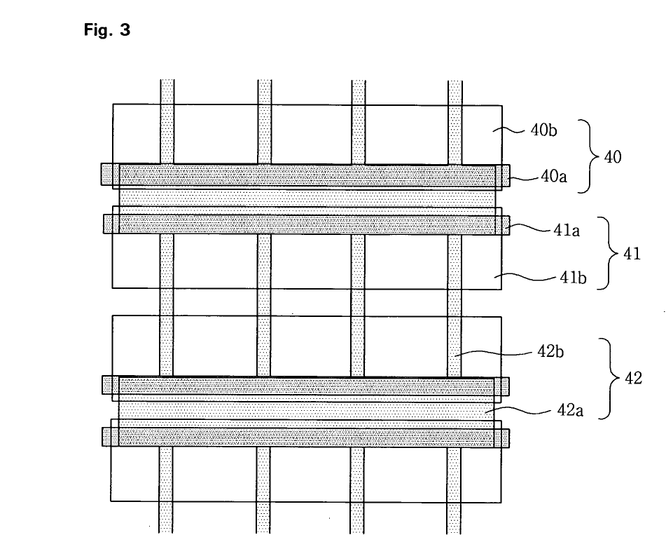

FIG. 4 shows modified traverse barrier ribs of a plasma display panel in the related art;

FIG. 5 is a plan view of a plasma display panel according to a first embodiment of the present invention;

FIG. 6 is a plan view of a plasma display panel according to a second embodiment of the present invention; and

FIG. 7 is a plan view of a plasma display panel according to a third embodiment of the present invention.

### DETAILED DESCRIPTION OF THE PREFERRED EMBODIMENT

A plasma display panel according to a first embodiment of the present invention comprises a first barrier rib, which partitions discharge cells in a first direction and has one or more holes formed therein, a second barrier rib, which partitions the discharge cells in the first direction and is formed between one first barrier rib and the other first barrier rib, a first electrode formed to overlap with the first barrier rib and a discharge cell region, and a second electrode formed on the second barrier rib.

The first barrier rib and the second barrier rib may be traverse barrier ribs.

The holes may be formed in each region between one discharge cell and an adjacent discharge cell.

The hole may be formed in at least one region among a plurality of regions, wherein one region is the space between one discharge cell and an adjacent discharge cell.

The second barrier rib may be formed alternately with the first barrier rib.

One or more second barrier ribs may be formed between one first barrier rib and the other first barrier rib.

The first electrode may serve as a scan electrode and the second electrode serves as a sustain electrode.

A plasma display panel according to a second embodiment of the present invention comprises a first barrier rib, which partitions discharge cells in a first direction and has one or more holes formed therein, a second barrier rib, which partitions the discharge cells in the first direction, and comprises a groove formed in the first direction, and is formed between one first barrier rib and the other first barrier rib, a first electrode formed to overlap with the first barrier rib and a discharge cell region, and a second electrode formed on the second barrier rib.

The groove may be formed on the entire second barrier rib.

The groove may be formed on part of the second barrier rib.

The first electrode may serve as a scan electrode and the second electrode serves as a sustain electrode.

The second barrier rib may be formed alternately with the first barrier rib.

One or more second barrier ribs may be formed between one first barrier rib and the other first barrier rib.

A plasma display panel according to a third embodiment of the present invention comprises a first barrier rib, which partitions discharge cells in a first direction and has one or more holes formed therein, a second barrier rib, which partitions the discharge cells in the first direction, and comprises a groove formed in the first direction, and is formed between one first barrier rib and the other first barrier rib, a first electrode formed to overlap with the first barrier rib and a discharge cell region, and a second electrode formed on a groove of the second barrier rib.

The groove may be formed on the entire second barrier rib.

The groove may be formed on part of the second barrier rib.

The first electrode may serve as a scan electrode and the second electrode serves as a sustain electrode.

The second barrier rib may be formed alternately with the first barrier rib.

One or more second barrier ribs may be formed between one first barrier rib and the other first barrier rib.

the second electrode generates a discharge in upper discharges cells and lower discharge cells, wherein the upper discharges are adjacent to -he lower discharge cells.

A plasma display panel in accordance with the present invention can reduce power consumption and can reduce capacitance between barrier ribs and electrodes, while smoothly performing an address discharge.

The present invention will now be described in detail in connection with preferred embodiments with reference to the accompanying drawings.

### Embodiment 1

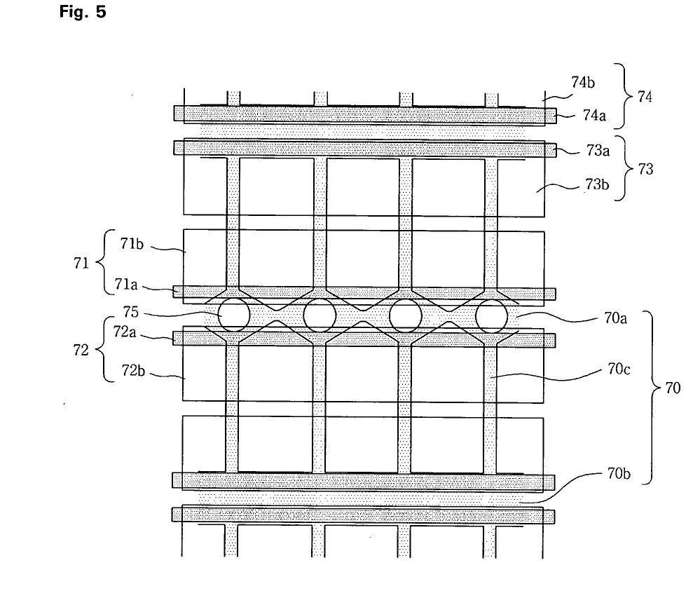

FIG. 5 is a plan view of a plasma display panel according to a first embodiment of the present invention.

As shown in FIG. 5, the plasma display panel according to the present invention comprises a first barrier rib 70a, a second barrier rib 70b, a third barrier rib 70c, first electrodes 71 and 72 and second electrodes 73 and 74.

The first barrier rib 70a partitions discharge cells in a first direction and has one or more holes 75 formed therein. The first barrier rib 70a of FIG. 5 is a barrier rib in a traverse direction and partitions upper discharge cells and lower discharge cells. The one or more holes 75 function to reduce capacitance between the first electrodes 71 and 72 and the first barrier rib 70a. The hole 75 can be formed in each region between one discharge cell and an adjacent discharge cell as shown in FIG. 5. The hole 75 can be formed in at least one region among a plurality of regions. One region is the space between one discharge cell and an adjacent discharge cell.

The second barrier rib 70b partitions the discharge cells in the first direction and is formed between one first barrier rib 70a and the other first barrier rib 70a. The second barrier rib 70b of FIG. 5 is a barrier rib in a traverse direction and partitions the upper discharge cells and lower discharge cells. The second barrier rib 70b can be formed alternately with the first barrier rib 70a, as shown in FIG. 5.

One or more second barrier rib 70b can be formed between one first barrier rib 70a and the other first barrier rib 70a. For example, where a first barrier rib comprises a first traverse barrier rib and a fifth traverse barrier rib, three traverse barrier ribs are formed between the first traverse barrier rib and the fifth traverse barrier rib. One or more of the three traverse barrier ribs can be formed as a second barrier rib.

The third barrier rib 70c partitions the discharge cells in a second direction. That is, the third barrier rib 70c is a barrier rib in a longitudinal direction and partitions right side discharge cells and left side discharge cells.

The first electrodes 71 and 72 are formed to overlap with the first barrier rib 70a and a discharge cell region. The first electrode 71 comprises a bus electrode 71a and a transparent electrode 71b. The first electrode 72 comprises a bus electrode 72b and a transparent electrode 72b. As shown in FIG. 5, the first electrodes 71 and 72 are also overlapped with part of the first barrier rib 70a and are also overlapped with part of the interior of the discharge cells. As described above, since the first electrodes 71 and 72 are exposed to the discharge cell region, an address discharge can be increased.

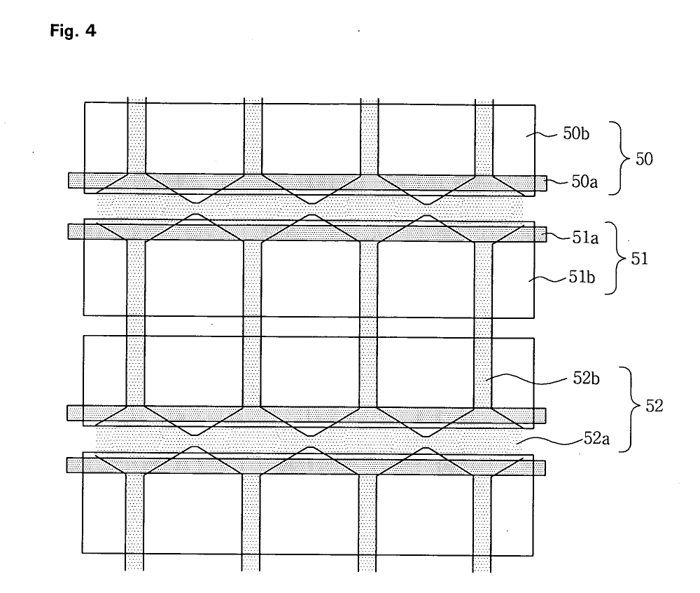

The second electrodes 73 and 74 are formed on the second barrier rib 70b. The second electrode 73 comprises a bus electrode 73a and a transparent electrode 73b. The second electrode 74 comprises a bus electrode 74b and a transparent electrode 4b. The second electrodes 73 and 74 are not exposed to the discharge cell region unlike the first electrodes 71 and 72. Therefore, power consumption incurred by the barrier rib structure of FIG. 5 is less than power consumption incurred by the barrier rib structure of FIG. 4.

Since an address discharge is performed by the address electrodes and the scan electrodes, the sustain electrodes need not to be exposed to the discharge cell region. As a result, the first electrodes 71 and 72 serve as scan electrodes and the second electrodes 73 and 74 serve as sustain electrodes.

### Embodiment 2

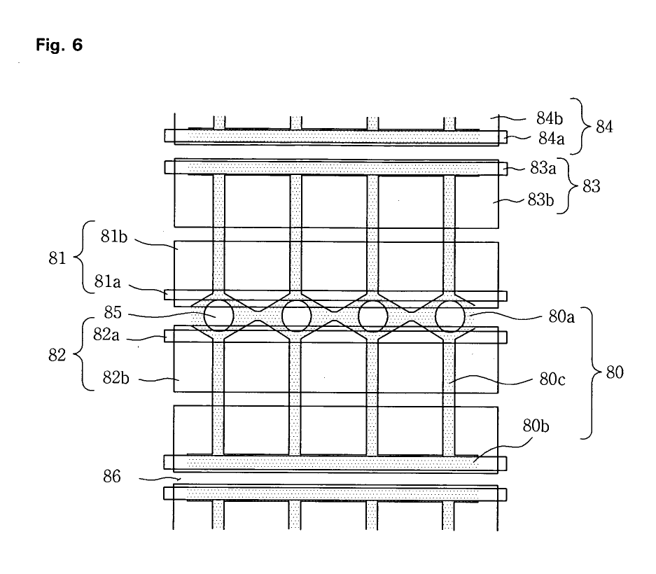

FIG. 6 is a plan view of a plasma display panel according to a second embodiment of the present invention. As shown in FIG. 6, the plasma display panel comprises a first barrier rib 80a, a second barrier rib 80b, a third barrier rib 80c, first electrodes 81 and 82 and second electrodes 83 and 84.

The first barrier rib 80a partitions discharge cells in a first direction and has one or more holes 85 formed therein. The first barrier rib 80a of FIG. 6 is a barrier rib in a traverse direction and partitions upper discharge cells and lower discharge cells. The one or more holes 85 function to reduce capacitance between the first electrodes 81 and 82 and the first barrier rib 80a. The hole 85 can be formed in each region between one discharge cell and an adjacent discharge cell as shown in FIG. 6. The hole 85 can be formed in at least one region among a plurality of regions. One region is the space between one discharge cell and an adjacent discharge cell.

The second barrier rib 80b partitions the discharge cells in the first direction and is formed between one first barrier rib 80a and the other first barrier rib 80a. The second barrier rib 80b comprises a groove 86 in the first direction. The second barrier rib 80b of FIG. 6 is a barrier rib in a traverse direction and partitions upper discharge cells and lower discharge cells. The second barrier rib 80b can be formed alternately with the first barrier rib 80a, as shown in FIG. 6.

One or more second barrier rib 80b can be formed between one first barrier rib 80a and the other first barrier rib 80a. For example, where the first barrier rib comprises a first traverse barrier rib and a fifth traverse barrier rib, three traverse barrier ribs are formed between the first traverse barrier rib and the fifth traverse barrier rib. One or more of the three traverse barrier ribs can be formed as a second barrier rib. The groove 86 formed on the second barrier rib 80b can be formed on the entire second barrier rib 80b, as shown in FIG. 6. The groove 86 can be formed on part of the second barrier rib 80b. The groove 86 functions to reduce capacitance between the second barrier rib 80b and the second electrodes 83 and 84. In addition, the groove 86 improves an exhaust characteristic of the plasma display panel.

The third barrier rib 80c partitions the discharge cells in a second direction. That is, the third barrier rib 80c is a barrier rib in a longitudinal direction and partitions right side discharge cells and left side discharge cells.

The first electrodes 81 and 82 are formed to overlap with the first barrier rib 80a and a discharge cell region. The first electrode 81 comprises a bus electrode 81a and a transparent electrode 81b. The first electrode 82 comprises a bus electrode 82b and a transparent electrode 82b. As shown in FIG. 6, the first electrodes 81 and 82 are also overlapped with part of the first barrier rib 80a and are also overlapped with part of the interior of the discharge cells. As described above, since the first electrodes 81 and 82 are exposed to the discharge cell region, an address discharge can be increased.

The second electrodes 83 and 84 are formed on the second barrier rib 80b. The second electrode 83 comprises a bus electrode 83a and a transparent electrode 83b. The second electrode 84 comprises a bus electrode 84b and a transparent electrode 4b. The second electrodes 83 and 84 are not exposed to the discharge cell region unlike the first electrodes 81 and 82. Therefore, power consumption incurred by the barrier rib structure of FIG. 6 is less than power consumption incurred by the barrier rib structure of FIG. 4.

Since an address discharge is performed by the address electrodes and the scan electrodes, the sustain electrodes need not to be exposed to the discharge cell region. As a result, the first electrodes 81 and 82 serve as scan electrodes and the second electrodes 83 and 84 serve as sustain electrodes.

### Embodiment 3

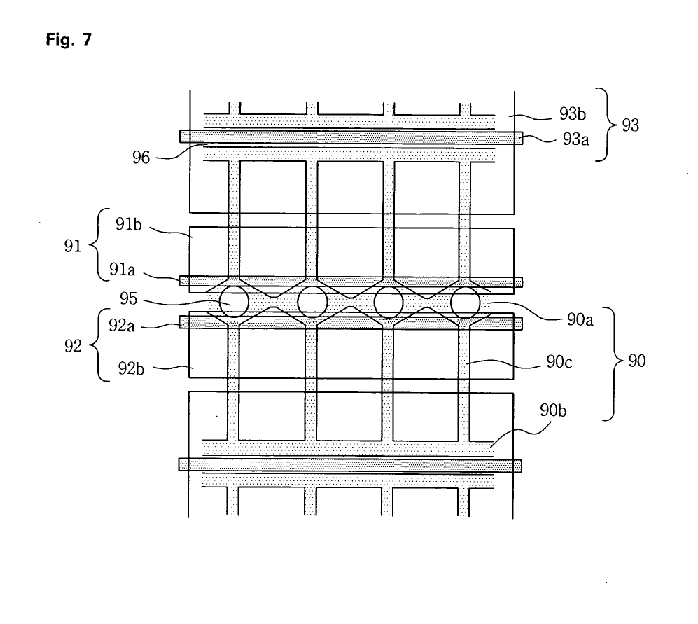

FIG. 7 is a plan view of a plasma display panel according to a third embodiment of the present invention. As shown in FIG. 7, the plasma display panel comprises a first barrier rib 90a, a second barrier rib 90b, a third barrier rib 90c, first electrodes 91 and 92 and a second electrode 93. Embodiment 3 is different from Embodiment 2 in that the second electrode 93 of Embodiment 3 is formed on a groove 96.

The first barrier rib 90a partitions discharge cells in a first direction and has one or more holes 95 formed therein. The first barrier rib 90a of FIG. 7 is a barrier rib in a traverse direction and partitions upper discharge cells and lower discharge cells. The one or more holes 95 function to reduce capacitance between the first electrodes 91 and 92 and the first barrier rib 90a. The hole 95 can be formed in each region between one discharge cell and an adjacent discharge cell as shown in FIG. 7. The hole 95 can be formed in at least one region among a plurality of regions, wherein one region is the space between one discharge cell and an adjacent discharge cell.

The second barrier rib 90b partitions the discharge cells in the first direction and is formed between one first barrier rib 90a and the other first barrier rib 90a. The second barrier rib 90b comprises a groove 96 in the first direction. The second barrier rib 90b of FIG. 7 is a barrier rib in a traverse direction and partitions upper discharge cells and lower discharge cells. The second barrier rib 90b can be formed alternately with the first barrier rib 90a, as shown in FIG. 7.

One or more second barrier rib 90b can be formed between one first barrier rib 90a and the other first barrier rib 90a. For example, where the first barrier comprises a first traverse barrier rib and a fifth traverse barrier rib, three traverse barrier ribs are formed between the first traverse barrier rib and the fifth traverse barrier rib. One or more of the three traverse barrier ribs can be formed as a second barrier rib. The groove 96 formed on the second barrier rib 90b can be formed on the entire second barrier rib 90b, as shown in FIG. 7. The groove 96 can be formed on part of the second barrier rib 90b. The groove 96 functions to reduce capacitance between the second barrier rib 90b and the second electrodes 93 and 94. In addition, the groove 96 improves an exhaust characteristic of the plasma display panel.

The third barrier rib 90c partitions the discharge cells in a second direction. That is, the third barrier rib 90c is a barrier rib in a longitudinal direction and partitions right side discharge cells and left side discharge cells.

The first electrodes 91 and 92 are formed to overlap with the first barrier rib 90a and a discharge cell region. The first electrode 91 comprises a bus electrode 91a and a transparent electrode 91b. The first electrode 92 comprises a bus electrode 92b and a transparent electrode 92b. As shown in FIG. 7, the first electrodes 91 and 92 are also overlapped with part of the first barrier rib 90a and are also overlapped with part of the interior of the discharge cells. As described above, since the first electrodes 91 and 92 are exposed to the discharge cell region, an address discharge can be increased.

The second electrode 93 is formed on the groove 96 of the second barrier rib 90b. The second electrode 93 generates a discharge in upper discharge cells and lower discharge cells. The upper discharges are adjacent to the lower discharge cells.

That is, the second electrode 83 of the second embodiment generates a discharge in discharge cells on an upper side and the second electrode 84 generates a discharge in discharge cells on a lower side.

Meanwhile, the second electrode 93 of the third embodiment generates a discharge in upper discharge cells and lower discharge cells. Since the second electrode 93 is formed on the groove 96 of the second barrier rib 90b, capacitance between the second electrode 93 and the second barrier rib 90b decreases.

The second electrode 93 comprises a bus electrode 93a and a transparent electrode 93b. The second electrode 93 is not exposed to the discharge cell region unlike the first electrodes 91 and 92. Therefore, power consumption incurred by the barrier rib structure of FIG. 7 is less than power consumption incurred by the barrier rib structure of FIG. 4.

Since an address discharge is performed by the address electrodes and the scan electrodes, the sustain electrodes need not to be exposed to the discharge cell region. As a result, the first electrodes 91 and 92 serve as scan electrodes and the second electrodes 93 and 94 serve as sustain electrodes. The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display panel, comprising:
a first barrier rib partitioning discharge cells in a first direction and having one or more holes formed therein;
a barrier rib partitioning the discharge cells in the first direction and formed between one first barrier rib and the other first barrier rib;
a first electrode formed to overlap with the first barrier rib and a discharge cell region; and
a second electrode formed on the second barrier rib.

2. The plasma display panel as claimed in claim 1, wherein the first barrier rib and the second barrier rib are traverse barrier ribs.

3. The plasma display panel as claimed in claim 1, wherein the hole is formed in each region between one discharge cell and an adjacent discharge cell.

4. The plasma display panel as claimed in claim 1, wherein the hole is formed in at least one region among a plurality of regions, wherein one region is the space between one discharge cell and an adjacent discharge cell.

5. The plasma display panel as claimed in claim 1, wherein the second barrier rib is formed alternately with the first barrier rib.

6. The plasma display panel as claimed in claim 1, wherein one or more second barrier ribs are formed between one first barrier rib and the other first barrier rib.

7. The plasma display panel as claimed in claim 1, wherein the first electrode serves as a scan electrode and the second electrode serves as a sustain electrode.

8. A plasma display panel, comprising:
a first barrier rib partitioning discharge cells in a first direction and having one or more holes formed therein;
a second barrier rib partitioning the discharge cells in the first direction and comprising a groove formed in the first direction and formed between one first barrier rib and the other first barrier rib;
a first electrode formed to overlap with the first barrier rib and a discharge cell region; and
a second electrode formed on the second barrier rib.

9. The plasma display panel as claimed in claim 8, wherein the groove is formed on the entire second barrier rib.

10. The plasma display panel as claimed in claim 8, wherein the groove is formed on a part of the second barrier rib.

11. The plasma display panel as claimed in claim 8, wherein the first electrode serves as a scan electrode and the second electrode serves as a sustain electrode.

12. The plasma display panel as claimed in claim 8, wherein the second barrier rib is formed alternately with the first barrier rib.

13. The plasma display panel as claimed in claim 8, wherein one or more second barrier ribs are formed between one first barrier rib and the other first barrier rib.

14. A plasma display panel, comprising:
a first barrier rib partitioning discharge cells in a first direction and having one or more holes formed therein;
a second barrier rib partitioning the discharge cells in the first direction and comprising a groove formed in the first direction and formed between one first barrier rib and the other first barrier rib;
a first electrode formed to overlap with the first barrier rib and a discharge cell region; and
a second electrode formed on a groove of the second barrier rib.

15. The plasma display panel as claimed in claim 14, wherein the groove is formed on the entire second barrier rib.

16. The plasma display panel as claimed in claim 14, wherein the groove is formed on part of the second barrier rib.

17. The plasma display panel as claimed in claim 14, wherein the first electrode serves as a scan electrode and the second electrode serves as a sustain electrode.

18. The plasma display panel as claimed in claim 14, wherein the second barrier rib is formed alternately with the first barrier rib.

19. The plasma display panel as claimed in claim 14, wherein one or more second barrier ribs are formed between one first barrier rib and the other first barrier rib.

20. The plasma display panel as claimed in claim 14, wherein the second electrode generates a discharge in upper discharges cells and lower discharge cells, wherein the upper discharges are adjacent to the lower discharge cells.
